(19) United States
(12) Patent Application Publication
(10) Pub. No.: US 2005/0075884 A1
(43) Pub. Date: Apr. 7, 2005

(54) Multi-modal input form with dictionary and grammar

(76) Inventor: Sig Harold Badt JR., Richardson, TX (US)

Correspondence Address: ALCATEL USA;INTELLECTUAL PROPERTY DEPARTMENT, 3400 W. PLANO PARKWAY, MS LEGL2, PLANO, TX, 75075, US

(21) Appl. No.: 10/676,590

(22) Filed: Oct. 1, 2003

(51) Int. Cl. G10L 21/00

(52) U.S. Cl. 704/275

(57) ABSTRACT

A voice recognition system with a graphical user interface (GUI) is provided by the present invention for visually prompting a user for expected inputs that the user can choose to speak at designated points in a dialog in order to improve the overall accuracy of the voice recognition system. By reading the GUI window, the user can know what the recognizable grammar and vocabulary are for spoken input at any moment in the dialog. The GUI and voice interface can be built from a single dictionary and grammar specification. Prompts that represent non-terminal tokens in the grammar are replaced with one of a set of other prompts in the grammar in response to spoken input. The GUI may further comprise pull-down menus as well as separate windows that open and close in response to user input. The system may also verbally prompt the user to provide certain spoken input.

### BACKGROUND OF THE INVENTION

1. Technical Field

The present invention relates generally to voice recognition technology and more specifically to a method for providing guidance to a user as to which verbal inputs are recognizable by a voice recognition system.

2. Description of Related Art

With the current state of the art, it is sometimes only possible for an automatic speech recognition (ASR) system to recognize a fixed set of a few hundred words and phrases at a given time. For example, at a certain moment in a human/computer dialog, it may be possible for the ASR system to recognize the phrase, “Book a flight from Boston to Chicago,” but it may not be possible to recognize, “Book a seat from Boston to Chicago.” Thus, at a given point in a human/computer dialog the ASR system can only recognize phrases that conform to a limited dictionary and grammar.

Because of these limitations in ASR software, the human user is only allowed to say certain things at certain points in the dialog. The problem is that, a human user does not always know what is the acceptable dictionary and grammar at the current point in the human/computer dialog. For example, at a given point in a dialog a user may not know if he or she should say “Book a flight” or “Book a seat.”

Several solutions have been proposed for smoothing over the difficulties encountered with ASR. A system can be designed in such a way that it is obvious to most human users what should be said at every point in the human/computer dialog. Alternatively, a system designer may try to consider all possible things a human user might want to say at any point in the dialog. Another solution is to train the human user in the use of the system.

All of the above solutions may fail. It may not be obvious to a user as to what grammar is appropriate at particular points of a human/machine dialog. Additionally, the universe of choices that the human user may say is so large the system designer cannot explicitly list them all. Many users of the system may have no access to training.

Therefore, it would be desirable to have a voice recognition system that provides a user with allowable verbal responses at specific points in a human/machine dialog.

### SUMMARY OF THE INVENTION

The present invention provides a voice recognition system with a graphical user interface (GUI) that visually prompts a user for expected inputs that the user can choose to speak at designated points in a dialog to improve the overall accuracy of the voice recognition system. By reading the GUI window, the user can know what the recognizable grammar and vocabulary are for spoken input at any moment in the dialog. The GUI and voice interface can be built from a single dictionary and grammar specification. Prompts that represent non-terminal tokens in the grammar are replaced with one of a set of other prompts in the grammar in response to spoken input. The GUI may further comprise pull-down menus as well as separate windows that open and close in response to user input. The system may also use Text To Speech (TTS) technology to verbally prompt the user to provide certain spoken input.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented;

FIGS. 3A-3F show graphical user interface windows for use in a multi-modal automatic speech recognition (ASR) system in accordance with the present invention;

FIG. 4 illustrates a voice-only dialog using the same dictionary and grammar as that used in FIGS. 3A-3F;

FIG. 5 illustrates a more complex voice-only dialog in which the user knows some, but not all, of the dictionary and grammar that can be recognized by the ASR system;

FIG. 6 illustrates a voice-only dialog using reserved words; and

FIG. 7 illustrates another example of a voice-only dialog using a reserved word.

### DETAILED DESCRIPTION OF THE INVENTION

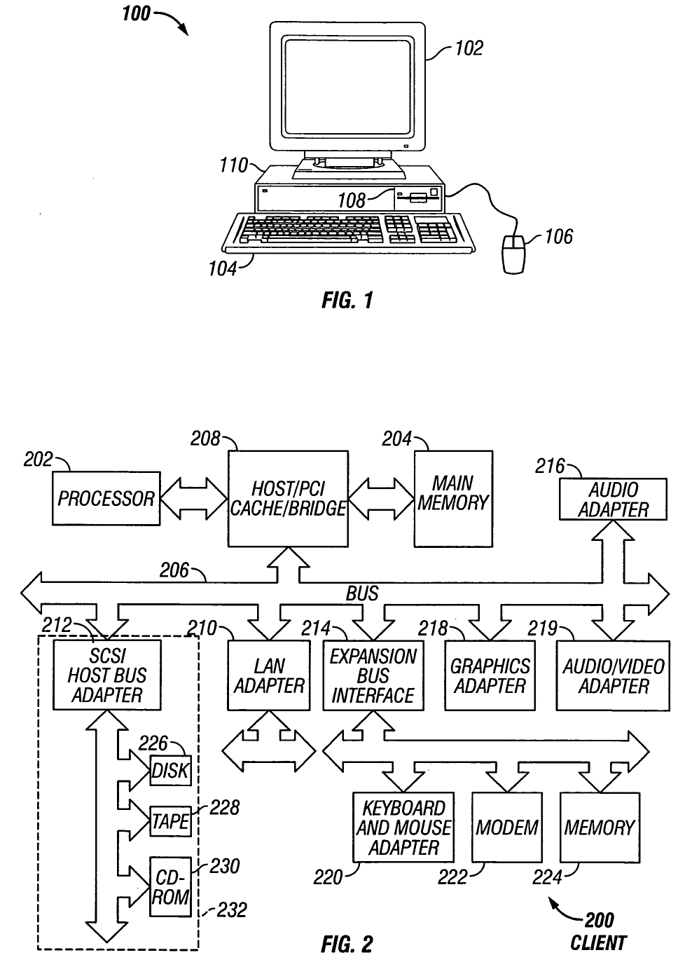

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

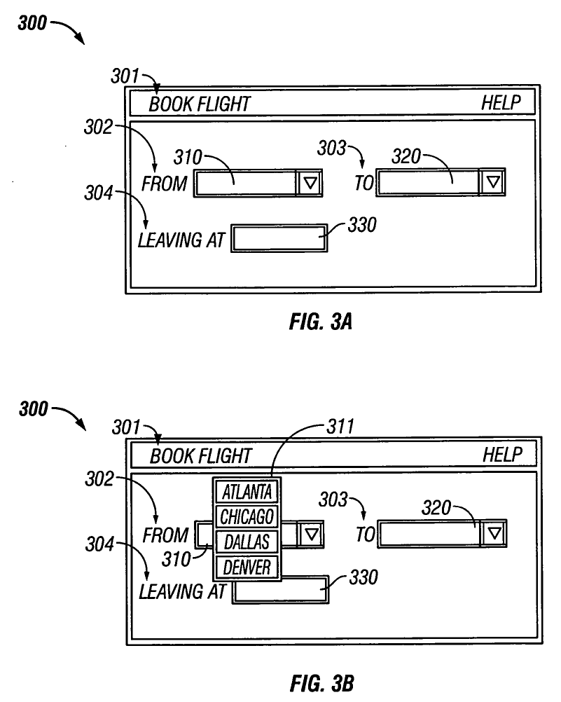

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202.

Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system. For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like.

As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

Computer users today are familiar with window-oriented graphical user interfaces (GUIs) or point-and-click interfaces. GUIs can be extended to include multi-modal interfaces, wherein the user can input information into the computer by using the mouse and keyboard in the conventional manner or by means of spoken, gestured, or hand written input. The user can also receive graphical or spoken output from the computer by means of GUIs and Text To Speech (TTS) technology.

A software module that makes it possible for a computer to understand spoken input is called an Automatic Speech Recognition (ASR) system. With the current state of the art, it is sometimes only possible for an ASR system to recognize a fixed set of few hundred words and phrases at a given time. For example, at a certain moment in a human/computer dialog, it may be possible for the ASR system to recognize the phrase, “Book a flight from Boston to Chicago,” but it may not be possible to recognize, “Book a seat from Boston to Chicago.” At a given point in a human/computer dialog the ASR system can only recognize phrases that conform to a limited dictionary and grammar.

With voice input, a human user does not always know what is the acceptable vocabulary and grammar at the current point in the human/computer dialog. Continuing the above example, at a given point in a dialog a user may not know if he or she should say “Book a flight” or “Book a seat.”

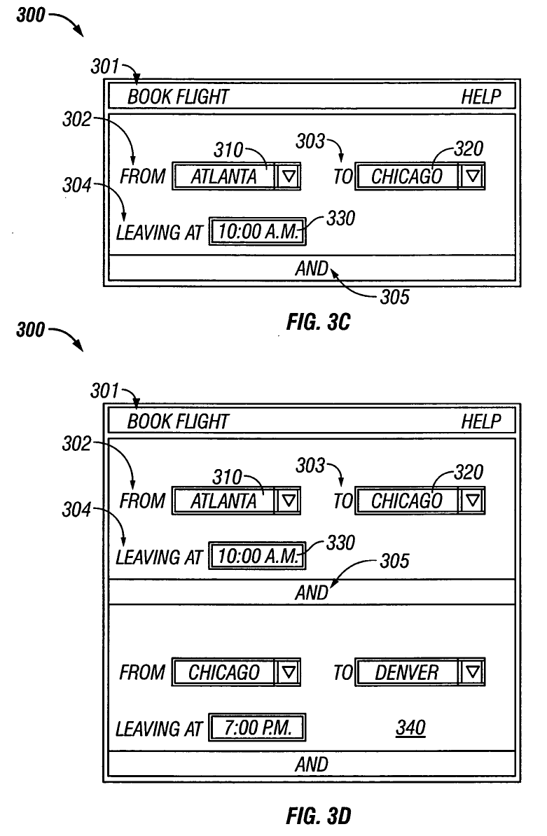

Referring now to FIG. 3A, a graphical user interface window for use in a multi-modal ASR system is depicted in accordance with the present invention. By reading the GUI window 300, the user can know what is the recognizable dictionary and grammar for spoken input at this moment in the dialog. In a conventional GUI window there is a bar across the top of the window (sometimes called the grab bar) that contains on its left side the name of the window. In FIG. 3A, the name 301 of the window 300 is “Book flight.” The user reads the window 300 from left to right and top to bottom, so any recognizable spoken input phrase for this window starts with the words “Book Flight”. After “Book Flight” 301, the user goes down to the next level and reads the word “from” 302.

In FIG. 3A, after the word “from” 302, is a GUI object called a pull-down input field 310. The user may not know what to say when he or she encounters this field. At this point, the user can say the reserved word, “list”. The system responds by displaying a list 311 of all recognizable inputs at this point in the dialog, as illustrated in FIG. 3B. The user speaks one of the words in this list 311. If a user encounters the pull-down input field 303, and the user already knows a recognizable input word, he or she can simply say the input word directly. Of course the GUI window 300 can also be used in the conventional point-and-click manner, by using the pull-down input field 310 with a mouse, stylus, or keyboard.

To the right of the pull-down input field 310 is the word “to” 303 and its associated pull-down input field 320, which operates in the same manner as the pull-down field 310 described above.

On the bottom line of the GUI window 300 is the label “leaving at” 303, with an associated text-input field 330. Again, the user may not know what the system can recognize as input to this field. At this point, the user can use a reserved word, which is an instruction from the user to the dialog controller. The dialog controller is a software-implemented control system that regulates the multi-modal dialog between the human user and the computer. The dialog controller performs functions such as loading the ASR system with the appropriate dictionary and grammar at the appropriate time and collecting information input by the user.

The following is an example list of reserved words and their respective meanings to the dialog controller:

What: What type of input is allowed at this time? or What input is allowed at this time?

Done: This scenario is finished.

And: Do again.

Review: Speak back to me what I just input.

List: List all possible things I can say at this time.

Of course, other reserve words are possible, depending on the subject of the dialog and the desired complexity of the system in question.

In the example in FIG. 3A, when the user comes to the “leaving at” label 304, he can say the reserved word, “what”. The system responds by speaking the words “time of day.” An alternative approach would be to put the words “time of day” directly above or below the field 330 (not shown). The user can then speak the time of day. FIG. 3C shows the text-input field 330 with a selected time of 10:00 AM.

Also show in FIG. 3C is a bar 305 across the bottom of the window 300 that contains the word “and”. When the user reaches the end of the window, the user can either say “done” or “and.” If the user says “done,” the window is complete. If the user says “and,” the window 300 expands as shown in FIG. 3D. The expanded section 340 of the GUI window 300 allows the user to book another flight using the same process as described above. Again, when the user reaches the bottom, he or she can say “done” to complete the process or “and” to book yet another flight.

FIG. 3E shows a version of the GUI window 300 that gives the user the option of making a special request 306. Next to the “special request” prompt 306 is an icon 307 that represents a new window. The icon 307 can be anywhere in the GUI window 300. If the user reaches the bottom of the window 300 shown in FIG. 3E, and has no special requests, the user can simply say the reserved word “done.”

However, if the user has a special request he or she would like to make (e.g., type of meal), the user can say the words “special request” and a new window 350 appears, as illustrated in FIG. 3F. The name of the new window 350 is also “special request”. The new window 350 incorporates pull-down input fields 351, 352 similar in function to pull-down field 310 described above. When the user finishes inputting data in the new window 350, input focus returns to the original window shown in FIG. 3E, just after the new window icon 307.

In order to assist in the human/computer dialog, special signals may have to be passed back and forth between the human user and the computer. Some of these signals indicate that one or the other wants to begin (or finish) speaking. For example, the human speaker may press and release a designated button to indicate that he or she is about to begin speaking. Alternatively, the speaker may press and hold down the button until he or she is finished speaking. The button may be a physical button or a GUI object. The computer may also display a “microphone open” indication when it can recognize spoken input from the user.

The computer may output a sound of some kind such as a chime or a tone when it is about to begin speaking and a second sound when it is finished speaking. These signals may or may not be necessary depending on the abilities of the system in question. The computer may also give a visual indication of the item on the screen that corresponds to the current point in the dialog. The location on the screen that corresponds to the current point in the dialog may be indicated by a moving arrow or highlight.

The same dictionary and grammar used for a multi-modal GUI interface of the kind described above can also be used for a voice-only interface. A voice-only dialog is the kind that can be conducted over a telephone with no graphic display.

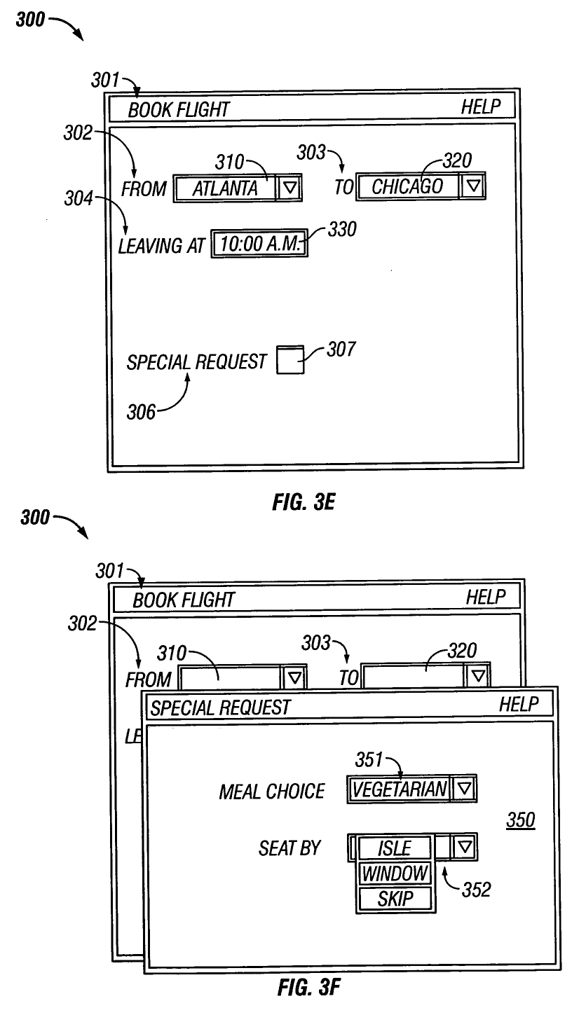

FIG. 4 shows a voice-only dialog using the same dictionary and grammar as that used in FIGS. 3A-3F but conducted entirely with voice interaction. FIG. 4 illustrates a simple voice-only dialog in which the speaker knows the dictionary and grammar that can be recognized by the ASR system before the dialog begins. In this example, the user knows the correct input that the system can recognize and simply speaks the necessary words.

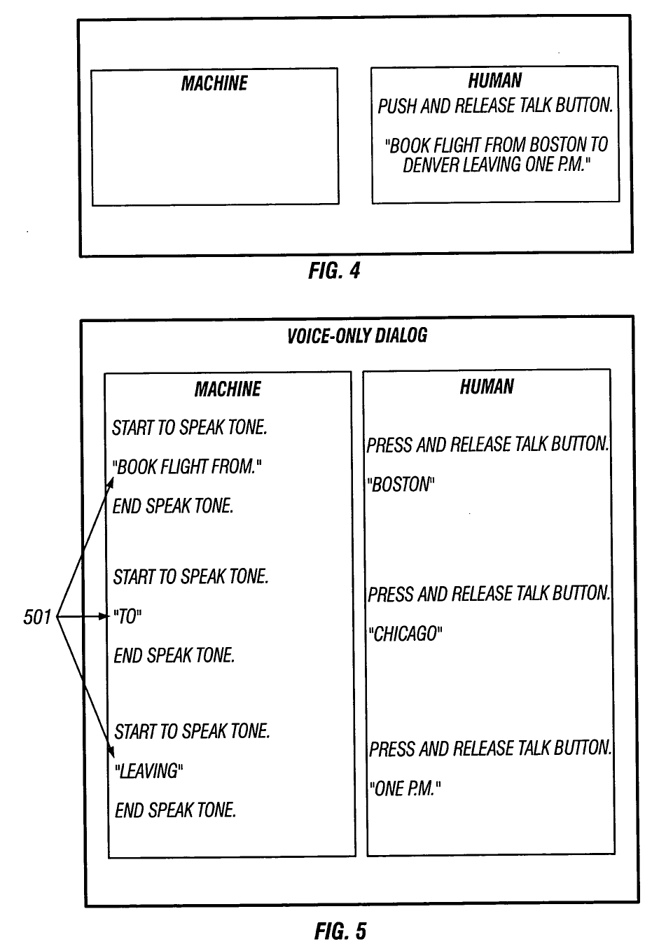

FIG. 5 illustrates a more complex voice-only dialog in which the user knows some, but not all, of the dictionary and grammar that can be recognized by the ASR system before the dialog begins. Again, the example uses the same dictionary and grammar used in FIGS. 3A-3F. In this example, the computer provides auditory prompts 501 to the user by speaking the “constant text” that the user would have otherwise have read from the screen. By relying on the auditory prompts 501 the user does not need to know all of the recognizable dictionary and grammar in advance.

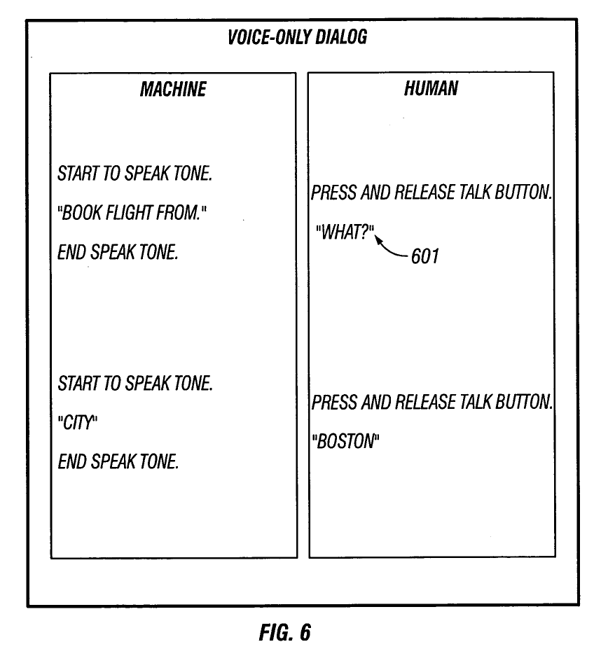

FIG. 6 is an example of a voice-only dialog using reserved words. Again, the dictionary and grammar are the same as the examples above. The reserved word 601 provides another level of functionality by allowing the user to prompt the computer for further guidance as to the correct type of input. When the user says “what”, the computer replies with the type of input expected next (i.e. city). However, in this example the system only tells the user the type of input that is expected but does not give an explicit list of all possible inputs that fall within that type.

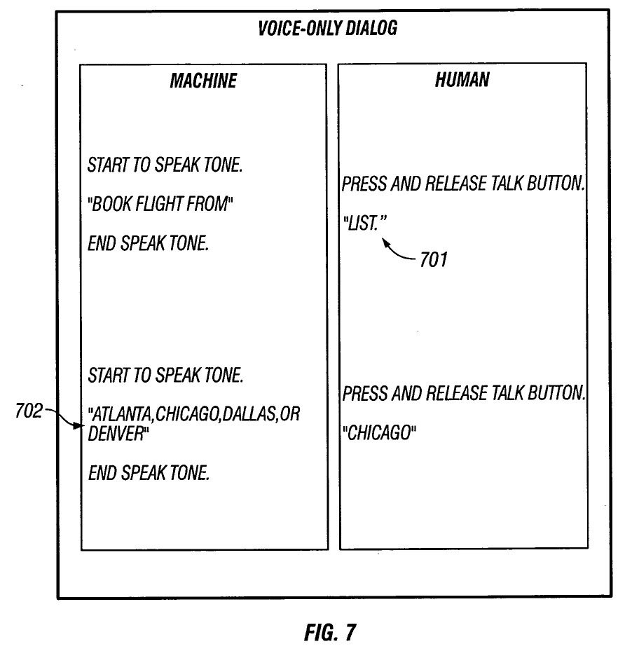

FIG. 7 shows another example of a voice-only dialog using reserved words. In this example, the reserved word 701 is “list”. In response to this reserved word, the computer replies with an explicit list 702 of all possible inputs at this point in the dialog.

It is possible to automatically build a GUI interface, a GUI plus voice interface, and a voice-only interface of the kinds described above from a single dictionary and grammar specification. A person skilled in the art can design a single formal language that can serve as input to an automatic multi-modal interface builder. It is also possible to specify the dictionary and grammar using a drag-and-drop automatic GUI builder similar to the kind commonly used in the art today.

The following is an example of a program that can produce the dialogs described above:

Main ReserveFlightDialog

```
Dialog ReserveFlightDialog
    {
    Repeatable
    Title “Book Flight”
    Body <FromCity> <ToCity> <LeavingTime> <SpecialRequestDialog>
    }
ChoiceList FromCity
    {
    Title “from”
    Entries “Atlanta”, “Chicago”, “Dallas”, “Denver”
    }
ChoiceList ToCity
    {
    Title “to”
    Entries “Atlanta”, “Chicago”, “Dallas”, “Denver”
    }
TimeField LeavingTime
    {
    Title “leaving at”
    }
Dialog SpecialRequestDialog
    {
    Title “special request”
    Body <MealChoice> <SeatBy>
    }
ChoiceList MealChoice
    {
    Title “meal choice”
    Entries “Vegetarian”, “Low Fat”, “Kosher”
    }
ChoiceList SeatBy
    {
    Title “seat by”
    Entries “Window”, “Aisle”, “Middle”
    }
```

A programmer can produce this program with a text editor. One can also build an Integrated Development Environment (IDE), which is a tool that helps write programs for a specific language (e.g., Visual Café for Java). An appropriate complier can then take the above program as input and produce the user interfaces described above. Such compliers are well known in the art.

Each prompt from the computer represents a token in the grammar specification that governs the human/machine dialog. If a prompt represents a non-terminal token, it is replaced with another prompt from the grammar in response to verbal input, which takes the user to the next defined step in the dialog. Using the example above in FIGS. 3A-3F, the prompts “from” and “to” represent non-terminal tokens that lead to subsequent dialog prompts after the user has provided verbal input. A terminal token relates to a natural stopping point in the dialog, after which no further input from the user is necessary. For example, in FIG. 3E, the prompt for special requests might be a terminal token since no further input is necessary from the user in order to complete the booking of the flight.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer interface system, comprising:
a microphone that receives audio input from a user;
a voice recognition mechanism; and
a graphical user interface that prompts the user for expected inputs that the user can speak at designated points in a dialog according to a specified grammar;
wherein prompts may specify the type of expected input;
wherein prompts may specify words that are recognized by the system.

2. The system according to claim 1, wherein prompts that represent non-terminal tokens in the grammar are replaced with one of a set of other prompts in the grammar in response to spoken input.

3. The system according to claim 1, wherein the graphical user interface is built automatically from a single dictionary and grammar specification.

4. The system according to claim 1, further comprising:
at least one speaker that provides audio prompts for expected inputs.

5. The system according to claim 1, wherein a prompt may further comprise a second graphical user interface window.

6. The system according to claim 1, wherein the graphical user interface further comprises a pull-down menu.

7. The system according to claim 1, further comprising a set of reserved words that activate specified prompts when spoken by the user.

8. A computer program product in a computer readable medium for use in a computer interface system, the computer program product comprising:
first instructions for receiving audio input from a user;
second instructions for automatic voice recognition; and
third instructions for displaying a graphical user interface that prompts the user for expected inputs that the user can speak at designated points in a dialog according to a specified grammar;
wherein prompts may specify the type of expected input;
wherein prompts may specify words that are recognized by the system.

9. The computer program product according to claim 8, wherein prompts that represent non-terminal tokens in the grammar are replaced with one of a set of other prompts in the grammar in response to spoken input.

10. The computer program product according to claim 8, wherein the graphical user interface is built automatically from a single dictionary and grammar specification.

11. The computer program product according to claim 8, further comprising:
fourth instructions for outputting audio prompts for expected inputs.

12. The computer program product according to claim 8, wherein a prompt may further comprise a second graphical user interface window.

13. The computer program product according to claim 8, wherein the graphical user interface further comprises a pull-down menu.

14. The computer program product according to claim 8, further comprising a set of reserved words that activate specified prompts when spoken by the user.

14. A method for interfacing between a computer and a human user, the method comprising the computer implemented steps of:
receiving audio input from the user;
interpreting the audio input via voice recognition; and
displaying a graphical user interface that prompts the user for expected inputs that the user can speak at designated points in a dialog according to a specified grammar;
wherein prompts may specify the type of expected input;
wherein prompts may specify words that are recognized by the system.

16. The method according to claim 15, wherein prompts that represent non-terminal tokens in the grammar are replaced with one of a set of other prompts in the grammar in response to spoken input.

17. The method according to claim 15, wherein the graphical user interface is built automatically from a single dictionary and grammar specification.

18. The method according to claim 15, further comprising:
outputting audio prompts for expected inputs.

19. The method according to claim 15, wherein a prompt may further comprise a second graphical user interface window.

20. The method according to claim 15, wherein the graphical user interface further comprises a pull-down menu.

21. The method according to claim 15, further comprising a set of reserved words that activate specified prompts when spoken by the user.
